(19) United States
(12) Patent Application Publication
(10) Pub. No.: US 2018/0083473 A1
(43) Pub. Date: Mar. 22, 2018

(54) VARIABLE CAPACITOR SERIES TUNING CONFIGURATION

(71) Applicant: QUALCOMM Incorporated, San Diego, CA (US)

(72) Inventors: Paolo MENEGOLI, San Jose, CA (US); Linda IRISH, San Diego, CA (US); Fabio Alessio MARINO, San Diego, CA (US)

(21) Appl. No.: 15/268,042

(22) Filed: Sep. 16, 2016

(51) Int. Cl. H02J 7/02; H02J 7/00; H02J 5/00

(52) U.S. Cl. CPC H02J 7/025; H02J 5/005; H02J 7/0052

(57) ABSTRACT

Techniques for tuning a resonant network are discussed. An example apparatus for controlling an output parameter with a resonant network comprising a differential-series circuit with a first variable reactive element on a first branch of the differential-series circuit and a second variable reactive element on a second branch of the differential-series circuit, such that the resonant network is coupled to an output circuit. The apparatus includes a common control element operably coupled to the first variable reactive element and the second variable reactive element, and a control circuit operably coupled to the output circuit and the common control element and configured to vary an impedance of the resonant network based on a value of the output parameter in the output circuit.

### FIELD

This application is generally related to wireless power charging of chargeable devices, and more particularly for using variable capacitors in a series tuning configuration to adjust a system output.

### BACKGROUND

A variety of electrical and electronic devices are powered via rechargeable batteries. Such devices include electric vehicles, mobile phones, portable music players, laptop computers, tablet computers, computer peripheral devices, communication devices (e.g., Bluetooth devices), digital cameras, hearing aids, and the like. Historically, rechargeable devices have been charged via wired connections through cables or other similar connectors that are physically connected to a power supply. More recently, wireless charging systems are being used to transfer power in free space to be used to charge rechargeable electronic devices or provide power to electronic devices. As such, wireless power transfer systems and methods that efficiently control and safely transfer power to electronic devices are desirable.

### SUMMARY

An example of an apparatus for controlling an output parameter with a resonant network according to the disclosure include the resonant network comprising a differential-series circuit with a first variable reactive element on a first branch of the differential-series circuit and a second variable reactive element on a second branch of the differential-series circuit, wherein the resonant network is coupled to an output circuit, a common control element operably coupled to the first variable reactive element and the second variable reactive element, and a control circuit operably coupled to the output circuit and the common control element and configured to vary an impedance of the resonant network based on a value of the output parameter in the output circuit.

Implementations of the apparatus may include one or more of the following features. The first variable reactive element and the second variable reactive element may be analog controlled variable capacitors. The first variable reactive element and the second variable reactive element may be Barium Strontium Titanate (BST) devices. The first variable reactive element and the second variable reactive element may be varactors. The control circuit may be configured to provide a positive voltage to the common control element. The output parameter may be a voltage in the output circuit. The output parameter may be an impedance value in the output circuit. The resonant network may include a third variable reactive element and a fourth variable reactive element in a shunt configuration between the first branch and the second branch, and the common control element may be operably coupled to the third variable reactive element and the fourth variable reactive element. The resonant network may include a power receiving element. The output circuit may include a rectifier circuit and a charge controller configured to charge a battery. The first branch and the second branch of the differential-series circuit may each include a high impedance resistor. The first branch and the second branch of the differential-series circuit are equal (e.g., have equal valued components).

An example of a method of controlling an output parameter with a resonant network according to the disclosure includes detecting the output parameter, such that the output parameter is associated with the resonant network and the resonant network includes a differential-series circuit with more than one analog controlled variable capacitors, determining a control signal based on the output parameter, and providing the control signal to a common control element, such that the common control element is operably coupled to the analog controlled variable capacitors.

Implementations of such a method may include one or more of the following features. The output parameter may be a voltage. The output parameter may be a measure of reflected power from a load. The control signal may be a positive voltage. The analog controlled variable capacitors may be in a differential-series configuration and a shunt configuration.

An example of a resonant circuit in a wireless power receiving unit according to the disclosure includes a power receiving element with a first inductor, a first high impedance component coupled in series to a second high impedance component, such that the first and second high impedance components are in a shunt configuration with respect to the power receiving element, a common control element with a first terminal coupled to a point between the first and second high impedance components and a second terminal operably coupled to ground, a first capacitor with a first terminal operably coupled to the first high impedance component and the power receiving element and a second terminal operably coupled to an output, a second capacitor with a first terminal operably coupled to the second high impedance component and the power receiving element and a second terminal operably coupled to the output, a first variable reactive element operably coupled in a parallel configuration to the first capacitor, the first variable reactive element including a control terminal operably coupled to ground via a third high impedance component, and a second variable reactive element operably coupled in a parallel configuration to the second capacitor, the second variable reactive element including a control terminal operably coupled to ground via a fourth high impedance component.

Implementations of such a resonant circuit may include one or more of the following features. The common control element may be configured to provide a positive voltage to the point between the first and second high impedance components. A first capacitance value in the first variable reactive element may be based on a voltage at the common control element. A second capacitance value in the second variable reactive element may be based on a voltage at the common control element. A first capacitance value in the first variable reactive element and a second capacitance value in the second variable reactive element may be based on a voltage at the common control element, such that the first capacitance value and the second capacitance value are equal. The first high impedance component, the second high impedance component, the third high impedance component and the fourth high impedance component may all be resistors. The first high impedance component, the second high impedance component, the third high impedance component and the fourth high impedance component may all have equal impedance values. A switch may be operably coupled in a parallel configuration to the first variable reactive element and configured to bypass the first variable reactive element when the switch is in a closed position. The output may include a rectifier circuit and a battery.

An example of an apparatus for controlling a resonant network according to the disclosure includes the resonant network comprising a differential-series circuit with a first variable reactive means on a first branch of the differential-series circuit and a second variable reactive means on a second branch of the differential-series circuit, and a common control means operably coupled to the first variable reactive means and the second variable reactive means, and configured to vary an impedance of the resonant network.

Implementation of such an apparatus may include one or more of the following features. The common control means may configured to provide a voltage to the first variable reactive means and the second variable reactive means to vary the impedance of the resonant network. The first variable reactive means and the second variable reactive means may be analog controlled variable capacitors. A switch means may be operably coupled to the first variable reactive means and configured to bypass the first variable reactive means when the switch means is closed.

Items and/or techniques described herein may provide one or more of the following capabilities, as well as other capabilities not mentioned. Output parameters may be controlled based on the tuning of a resonant network. A resonant network with a differential-series configuration may be controlled from a common (e.g., single) control point. Positive polarity may be used to control the impedance of the resonant network. As compared to resonant circuits with a shunt configuration, the linearity of the differential-series resonant network may be improved. The impact of electromagnetic interference (EMI) may be reduced. Higher voltages may be used in the differential-series resonant network. The capacitive area required for the differential-series configuration may be the same as with a shunt configuration. An over-voltage switch may be placed in one of the branches of the differential-series network to rapidly detune the network. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is a functional block diagram of an exemplary wireless power transfer system.

FIG. 2 is a functional block diagram of an example of another wireless power transfer system.

FIG. 3 is a schematic diagram of a portion of transmit circuitry or receive circuitry of FIG. 2 including a transmit or receive element.

FIG. 4 is a diagram of an exemplary wireless power transfer system with a control loop on the receive circuitry.

FIG. 5 is a diagram of an example of a resonant network with a variable capacitor in a shunt configuration.

FIG. 6 is a diagram of an example of a variable reactive element.

FIG. 7 is a diagram of an example of a resonant network in a differential-series configuration with a plurality of variable capacitors.

FIG. 8 is a multi-variable graph illustrating an example response of the resonant network in FIG. 7 to a change in a control voltage.

FIG. 9 is the example of a resonant network in FIG. 7 with an optional switch configured to short out a reactive element.

FIG. 10 is a graph illustrating the response of the resonant network in FIG. 9 to the detuning caused by closing the optional switch.

FIG. 11 is a diagram of an example of a resonant network in a differential-series configuration with a plurality of variable capacitors in both shunt and series configurations.

FIG. 12 is a flowchart of an example of a process of controlling a resonant network in a differential-series configuration.

### DETAILED DESCRIPTION

Techniques are discussed herein for wireless power transfer using resonant circuits. Wireless power transfer may refer to transferring any form of energy associated with electric fields, magnetic fields, electromagnetic fields, or otherwise from a transmitter to a receiver without physical electrical conductors attached to and connecting the transmitter to the receiver to deliver the power (e.g., power may be transferred through free space). The power output into a wireless field (e.g., a magnetic field or an electromagnetic field) may be received, captured by, or coupled to by a power receiving element to achieve power transfer. The transmitter transfers power to the receiver through a wireless coupling of the transmitter and receiver.

The output power of a receiver in a wireless power transfer may be controlled by varying the reactance of a resonant network (i.e., resonant circuit) within the receiver. One approach to changing and controlling the reactance in a resonant network includes varying the value of the capacitor in the resonant network. Variable capacitors may be used in some applications to change the reactance of a circuit. In general, there are two configurations of resonant networks. The first is series resonance and the second is parallel resonance. Parallel circuits may also be referred to “shunt” configurations. In a circuit with a shunt resonance configuration, a capacitor is placed in parallel to the inductive elements in the resonant network. The inductive element may be the receiver antenna, which is typically described as an inductor with a series resistance. In the case of series resonant configuration, a capacitor is placed in series with the inductive elements (e.g., the receiver antenna).

In both the shunt and series configuration, the resonant circuit may be tuned or detuned in or out of resonance by varying the capacitance. Tuning the resonant circuit may also be used to vary the output of the receiver. For example, the amount of power that is transferred to the output may be varied by detuning or tuning to resonance. An example differential circuit with a shunt configuration may be realized in a balanced circuit with two equal branches (i.e., similar components to create differential structures) stemming out of the shunt configured resonator. In general, a differential circuit enables a reduction in Electromagnetic Interference (EMI) caused by harmonic frequencies. A shunt configuration, however, can create problems with output voltage regulation because of reflective inductive impedance inherent in the parallel configuration. A series tuning configuration is generally more efficient and offers less inductive reflected impedance. For example, a resonant circuit in a differential-series configuration (e.g., two elements in series) may provide improved linearity (reduction of even undesired harmonics). A drawback to prior differential-series configurations, however, was the corresponding requirement to include multiple variable capacitors and controls to implement series tuning. Additionally, in a microelectronic device, two capacitors means doubling the capacitance values of the capacitors and therefore doubling the silicon area (e.g., cost) required.

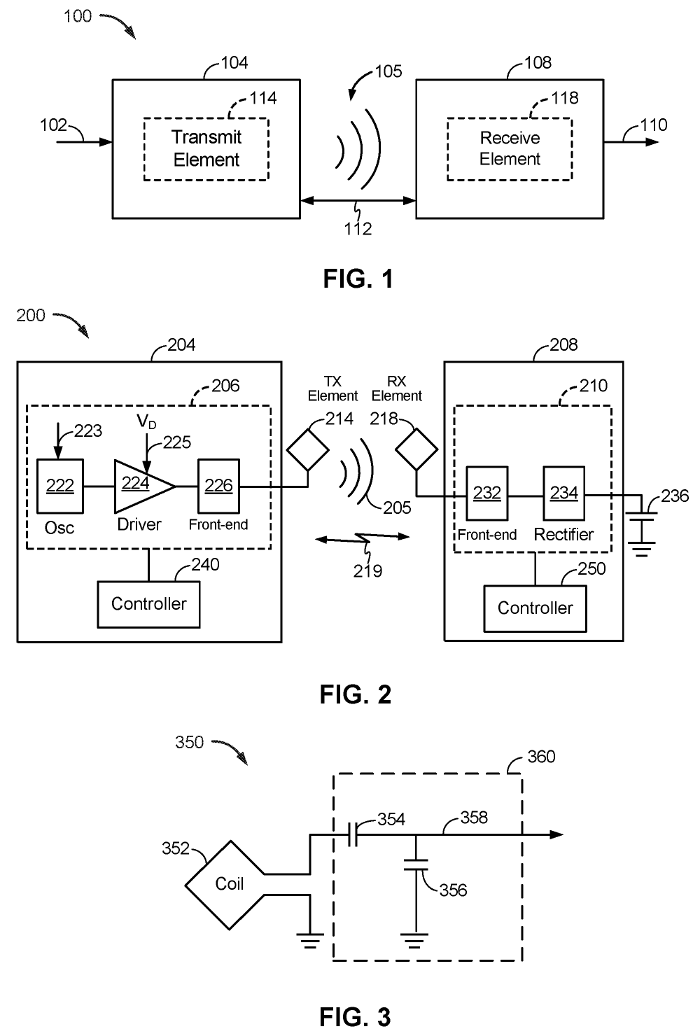

FIG. 1 is a functional block diagram of an example of a wireless power transfer system 100. Input power 102 may be provided to a transmitter 104 from a power source (not shown in this figure) to generate a wireless (e.g., magnetic or electromagnetic) field 105 for performing energy transfer. A receiver 108 may couple to the wireless field 105 and generate output power 110 for storing or consumption by a device (not shown in this figure) that is coupled to receive the output power 110. The transmitter 104 and the receiver 108 are separated by a non-zero distance 112. The transmitter 104 includes a power transmitting element 114 configured to transmit/couple energy to the receiver 108. The receiver 108 includes a power receiving element 118 configured to receive or capture/couple energy transmitted from the transmitter 104.

The transmitter 104 and the receiver 108 may be configured according to a mutual resonant relationship. When the resonant frequency of the receiver 108 and the resonant frequency of the transmitter 104 are substantially the same, transmission losses between the transmitter 104 and the receiver 108 are reduced compared to the resonant frequencies not being substantially the same. As such, wireless power transfer may be provided over larger distances when the resonant frequencies are substantially the same. Resonant inductive coupling techniques allow for improved efficiency and power transfer over various distances and with a variety of inductive power transmitting and receiving element configurations.

The wireless field 105 may correspond to the near field of the transmitter 104. The near field corresponds to a region in which there are strong reactive fields resulting from currents and charges in the power transmitting element 114 that do not significantly radiate power away from the power transmitting element 114. The near field may correspond to a region that up to about one wavelength, of the power transmitting element 114. Efficient energy transfer may occur by coupling a large portion of the energy in the wireless field 105 to the power receiving element 118 rather than propagating most of the energy in an electromagnetic wave to the far field.

The transmitter 104 may output a time-varying magnetic (or electromagnetic) field with a frequency corresponding to the resonant frequency of the power transmitting element 114. When the receiver 108 is within the wireless field 105, the time-varying magnetic (or electromagnetic) field may induce a current in the power receiving element 118. As described above, with the power receiving element 118 configured as a resonant circuit to resonate at the frequency of the power transmitting element 114, energy may be efficiently transferred. An alternating current (AC) signal induced in the power receiving element 118 may be rectified to produce a direct current (DC) signal that may be provided to charge an energy storage device (e.g., a battery) or to power a load.

FIG. 2 is a functional block diagram of an example of a wireless power transfer system 200. The system 200 includes a transmitter 204 and a receiver 208. The transmitter 204 (also referred to herein as power transmitting unit, PTU) is configured to provide power to a power transmitting element 214 that is configured to transmit power wirelessly to a power receiving element 218 that is configured to receive power from the power transmitting element 214 and to provide power to the receiver 208. Despite their names, the power transmitting element 214 and the power transmitting element 218, being passive elements, may transmit and receive power and communications.

The transmitter 204 includes the power transmitting element 214, transmit circuitry 206 that includes an oscillator 222, a driver circuit 224, and a front-end circuit 226. The power transmitting element 214 is shown outside the transmitter 204 to facilitate illustration of wireless power transfer using the power transmitting element 218. The oscillator 222 may be configured to generate an oscillator signal at a desired frequency that may adjust in response to a frequency control signal 223. The oscillator 222 may provide the oscillator signal to the driver circuit 224. The driver circuit 224 may be configured to drive the power transmitting element 214 at, for example, a resonant frequency of the power transmitting element 214 based on an input voltage signal (VD) 225. The driver circuit 224 may be a switching amplifier configured to receive a square wave from the oscillator 222 and output a sine wave.

The front-end circuit 226 may include a filter circuit configured to filter out harmonics or other unwanted frequencies. The front-end circuit 226 may include a matching circuit configured to match the impedance of the transmitter 204 to the impedance of the power transmitting element 214. As will be explained in more detail below, the front-end circuit 226 may include a tuning circuit to create a resonant circuit with the power transmitting element 214. As a result of driving the power transmitting element 214, the power transmitting element 214 may generate a wireless field 205 to wirelessly output power at a level sufficient for charging a battery 236, or powering a load.

The transmitter 204 further includes a controller 240 operably coupled to the transmit circuitry 206 and configured to control one or more aspects of the transmit circuitry 206, or accomplish other operations relevant to managing the transfer of power. The controller 240 may be a micro-controller or a processor. The controller 240 may be implemented as an application-specific integrated circuit (ASIC). The controller 240 may be operably connected, directly or indirectly, to each component of the transmit circuitry 206. The controller 240 may be further configured to receive information from each of the components of the transmit circuitry 206 and perform calculations based on the received information. The controller 240 may be configured to generate control signals (e.g., signal 223) for each of the components that may adjust the operation of that component. As such, the controller 240 may be configured to adjust or manage the power transfer based on a result of the operations performed by the controller 240. The transmitter 204 may further include a memory (not shown) configured to store data, for example, such as instructions for causing the controller 240 to perform particular functions, such as those related to management of wireless power transfer.

The receiver 208 (also referred to herein as a wireless power receiving unit, PRU) includes the power receiving element 218, and receive circuitry 210 that includes a front-end circuit 232 and a rectifier circuit 234. The power receiving element 218 is shown outside the receiver 208 to facilitate illustration of wireless power transfer using the power receiving element 218. The front-end circuit 232 may include matching circuitry configured to match the impedance of the receive circuitry 210 to the impedance of the power receiving element 218. As will be explained below, the front-end circuit 232 may further include a tuning circuit to create a resonant circuit with the power receiving element 218. The rectifier circuit 234 may generate a DC power output from an AC power input to charge the battery 236, as shown in FIG. 3. The receiver 208 and the transmitter 204 may additionally communicate on a separate communication channel 219 (e.g., BLUETOOTH, ZIGBEE, cellular, etc.). The receiver 208 and the transmitter 204 may alternatively communicate via in-band signaling using characteristics of the wireless field 205.

The receiver 208 may be configured to determine whether an amount of power transmitted by the transmitter 204 and received by the receiver 208 is appropriate for charging the battery 236. The transmitter 204 may be configured to generate a predominantly non-radiative field with a direct field coupling coefficient (k) for providing energy transfer. The receiver 208 may directly couple to the wireless field 205 and generate an output power for storing or consumption by a battery (or load) 236 coupled to the output or receive circuitry 210. In this example, the generated output power is associated with the resonant circuit in the front end 232 because the tuning of the resonant circuit will impact the amount of output power generated.

The receiver 208 further includes a controller 250 that may be configured similarly to the transmit controller 240 as described above for managing one or more aspects of the wireless power receiver 208. The receiver 208 may further include a memory (not shown) configured to store data, for example, such as instructions for causing the controller 250 to perform particular functions, such as those related to management of wireless power transfer.

As discussed above, transmitter 204 and receiver 208 may be separated by a distance and may be configured according to a mutual resonant relationship to try to minimize transmission losses between the transmitter 204 and the receiver 208.

FIG. 3 is a schematic diagram of an example of a portion of the transmit circuitry 206 or the receive circuitry 210 of FIG. 2. While a coil, and thus an inductive system, is shown in FIG. 3, other types of systems, such as capacitive systems for coupling power, may be used, with the coil replaced with an appropriate power transfer (e.g., transmit and/or receive) element. As illustrated in FIG. 3, transmit or receive circuitry 350 includes a power transmitting or receiving element 352 and a tuning circuit 360. The power transmitting or receiving element 352 may also be referred to or be configured as an antenna such as a “loop” antenna. The term “antenna” generally refers to a component that may wirelessly output energy for reception by another antenna and that may receive wireless energy from another antenna. The power transmitting or receiving element 352 may also be referred to herein or be configured as a “magnetic” antenna, such as an induction coil (as shown), a resonator, or a portion of a resonator. The power transmitting or receiving element 352 may also be referred to as a coil or resonator of a type that is configured to wirelessly output or receive power. As used herein, the power transmitting or receiving element 352 is an example of a “power transfer component” of a type that is configured to wirelessly output and/or receive power. The power transmitting or receiving element 352 may include an air core or a physical core such as a ferrite core (not shown).

When the power transmitting or receiving element 352 is configured as a resonant circuit or resonator with tuning circuit 360, the resonant frequency of the power transmitting or receiving element 352 may be based on the inductance and capacitance. Inductance may be simply the inductance created by a coil and/or other inductor forming the power transmitting or receiving element 352. Capacitance (e.g., a capacitor) may be provided by the tuning circuit 360 to create a resonant structure at a desired resonant frequency. As a non-limiting example, the tuning circuit 360 may comprise a capacitor 354 and a capacitor 356, which may be added to the transmit or receive circuitry 350 to create a resonant circuit.

The tuning circuit 360 may include other components to form a resonant circuit with the power transmitting or receiving element 352. As another non-limiting example, the tuning circuit 360 may include a capacitor (not shown) placed in parallel between the two terminals of the circuitry 350. Still other designs are possible. For example, the tuning circuit in the front-end circuit 226 may have the same design (e.g., 360) as the tuning circuit in the front-end circuit 232. Alternatively, the front-end circuit 226 may use a tuning circuit design different than in the front-end circuit 232.

For power transmitting elements, the signal 358, with a frequency that substantially corresponds to the resonant frequency of the power transmitting or receiving element 352, may be an input to the power transmitting or receiving element 352. For power receiving elements, the signal 358, with a frequency that substantially corresponds to the resonant frequency of the power transmitting or receiving element 352, may be an output from the power transmitting or receiving element 352. Although aspects disclosed herein may be generally directed to resonant wireless power transfer, persons of ordinary skill will appreciate that aspects disclosed herein may be used in non-resonant implementations for wireless power transfer.

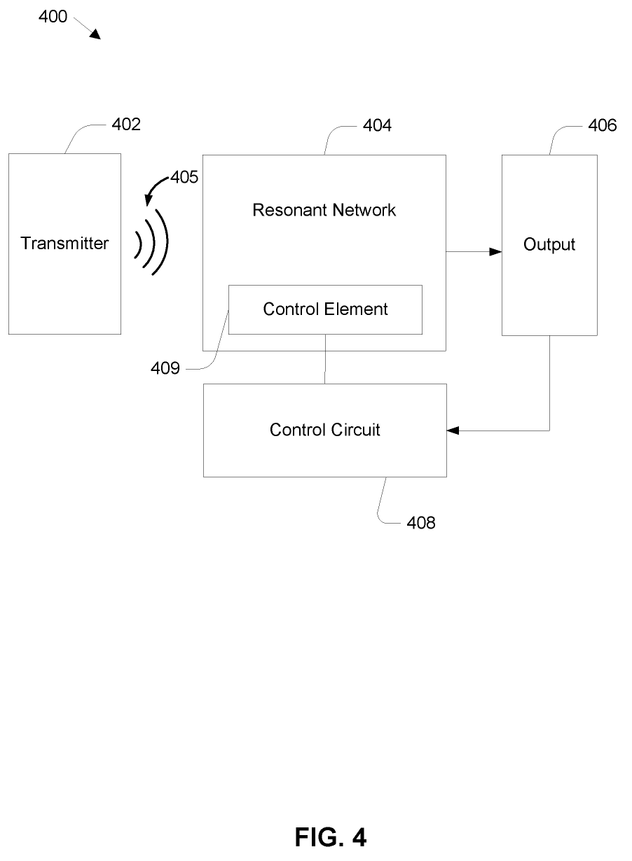

Referring to FIG. 4, a diagram of an exemplary wireless power transfer system 400 with a control loop on the receive circuitry is shown. The system 400 includes a transmitter 402 and resonant network 404 with a control element 409. The transmitter 402 is configured to output a time-varying field 405 (e.g., magnetic or electromagnetic) such as described for the transmit element 214. The resonant network 404 is configured to provide an output 406. The resonant network 404 may part of the front end 232 and the output 406 may receive an AC signal which is associated with the tuning of the resonant network 404. The output 406, for example, may be rectified (e.g., via rectifier 234) for use in power applications (e.g., battery charging with a charge controller). In an example, the output 406 may be an impedance matching device (e.g., antenna matching in a communication system). A control circuit 408 may be part of the controller 250 and is operably coupled to the output 406 and the control element 409. The resonant network 404 comprises a differential-series circuit with variable reactive elements (e.g., tuning capacitors, transcaps, variable capacitors, varactors, etc.). The control circuit 408 is configured to detune the resonant network 404 away from resonance or tune the resonant network 404 closer to resonance by providing a control signal to the control element 409. The control circuit 408 may be a micro-controller or a processor. In an example, the control circuit 408 may be implemented as an application-specific integrated circuit (ASIC). The control element 409 may be operably coupled to the variable reactive elements and configured to change the capacitive values of the elements via an analog control signal (e.g., a voltage). For example, the control circuit 408 may detect feedback parameter on the output 406 (e.g., a current, a voltage, a standing wave ratio, or other parameter), generate a control signal based on the feedback signal, and provide the control signal to the control element 409 to detune or tune the resonant network 404 based on the value of the output 406.

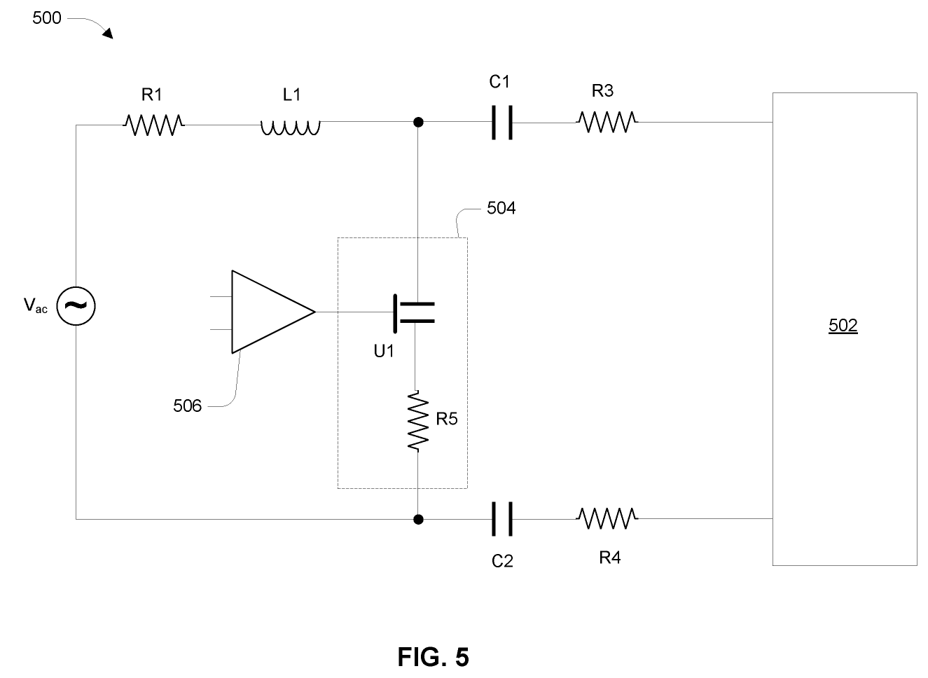

Referring to FIG. 5, a diagram of an exemplary resonant network 500 with a variable capacitor in a shunt configuration is shown. The resonant network 500 is part of a PRU (e.g., receive circuitry 350) and is operably coupled to an output circuit 502. The output circuit 502 may include additional application specific circuity such as EMI filters, rectifiers, and other output circuits in the PRU (not shown). The resonant network 500 is a typical shunt configuration circuit. A voltage generator V_{ac} simulates an induced voltage (e.g., the voltage that is induced into the resonant network from a transmitter 402). R1 represents a series resistance and L1 represents the inductance of the antenna/coil (e.g., receiving element 352). The values of the discrete components in the resonant network will vary based on specific application and required performance (e.g., power output). A charging solution for a small consumer product, for example, may utilize values of R1 is in a range between 500-1000 milliohms, and L1 may be in a range between 500-1000 nanohenries. The resonant network 500 includes a variable reactive element 504 in a shunt configuration. Examples of the variable reactive element 504 include a transcap, analog variable capacitor technologies, varactors, combinations of varactors, and Barium-Strontium Titanate (BST) dielectrics/devices. In an example, the variable reactive element 504 includes a variable capacitor U1 with a common control terminal operably coupled to an operational amplifier 506. A resistance R5 represents the internal resistance of the variable reactive element 504, and may have a value in the range of 10-100 milliohms. The variable capacitor U1 may be a semiconductor variable capacitor such as described in U.S. Patent Publication No. 2015/0194538, filed on Mar. 22, 2015, and titled “Multiple Control Transcap Variable Capacitor.” The resonant network 500 is a balanced differential circuit in that it includes two equal branches between the variable reactive element 504 and the output circuit 502 (e.g., C1, R3 and C2, R4). The components C1 and C2, and R3 and R4 are part of the resonant network 500. In a charging solution for a small wearable device, example capacitance values for C1 and C2 may be in the range of 100 picofarads to 100 nanofarads, and the resistance values for R3 and R4 may be in the value of 1 to 100 milliohms. The resonant network 500 may also be referred to as hybrid series and parallel configuration because the total capacitance in the resonant network 500 is based partially on the series capacitors C1 and C2, and partially on the parallel variable reactive element 504. The overall impedance of the resonant network 500, however, may be controlled via the common control terminal on the variable capacitor U1. For example, the operational amplifier 506 may provide a voltage to the control terminal on the variable capacitor U1 to change the capacitive value of the variable capacitor U1. Thus, the output of the operational amplifier 506 may be used to tune and detune the resonant network 500 and thus vary the associated output 502.

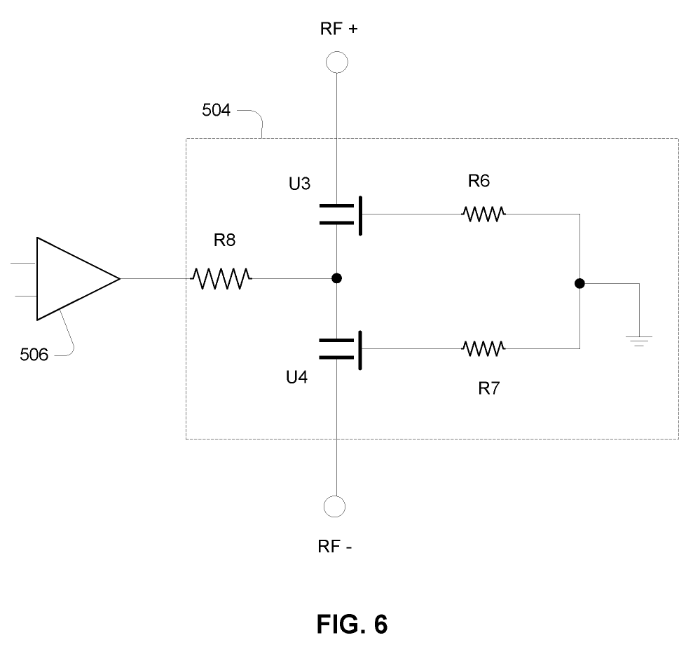

Referring to FIG. 6, with further reference to FIG. 5, a diagram of an example of a variable reactive element 504 is shown. In an example, the variable capacitor U1 in FIG. 5 is comprised of the elements shown in FIG. 6. The variable reactive element 504 represents a general configuration of transcaps, varactors and/or BST elements known in the art. The variable reactive element 504 includes three resistors R6, R7, R8 and two series elements U3 and U4 which are connected back-to-back. A control terminal (e.g., the op amp 506) is coupled to a high value resistance R8, and there are two separate terminals depicted to the right which are coupled to R6 and R7, which are then coupled to ground. In an example, the elements U3 and U4 are identical elements that constitute a differential-series transcap. The element U3 includes one terminal (i.e., the upper terminal in FIG. 6) connected to a RF+ area of the resonant network 500, and is typically a gate-oxide and poly-silicon type terminal. The element U4 includes one terminal (e.g., the lower terminal in FIG. 6) connected to the RF− of the resonant network 500, which is also typically a gate-oxide and poly-silicon type terminal. The other terminals on the elements U3 and U4 that couple to R8 are generally configured as semiconductor junctions (e.g., either a p type or an n type).

Referring back to FIG. 5, the resonant network 500 is relatively simple to control because there is only one element (U1) which is across the resonator and it is controlled with respect to the center voltage (node) of the differential structure (e.g., which, in the described differential application, is generally ground). Because control of U1 is referred to ground, the resonant network 500 may be classified as a differential and symmetrical circuit. As a symmetrical circuit, the resonant network 500 provides benefits such as decreased EMI, improved linearity, and reduced harmonics. As previously discussed, however, the shunt configuration of the resonant network 500 can provide challenges to voltage regulation and other issues due to reflected inductance/reactance from the antenna (e.g. L1). A series configuration may be used to overcome the limitations of a shunt configuration. In a series configuration, two additional variable capacitors are placed in series or in parallel to the capacitors C1 and C2 in the resonant network 500. Implementing a dual series configuration with two additional variable capacitors, however, can be more costly because it may require two control terminals and four times the capacitive area (silicon area associated with the capacitor) of an equivalent shunt tuning element. Thus, if a series approach is used, the manufacturing costs may be larger than a shunt approach because the series configured circuit may involve increased silicon area and additional control elements.

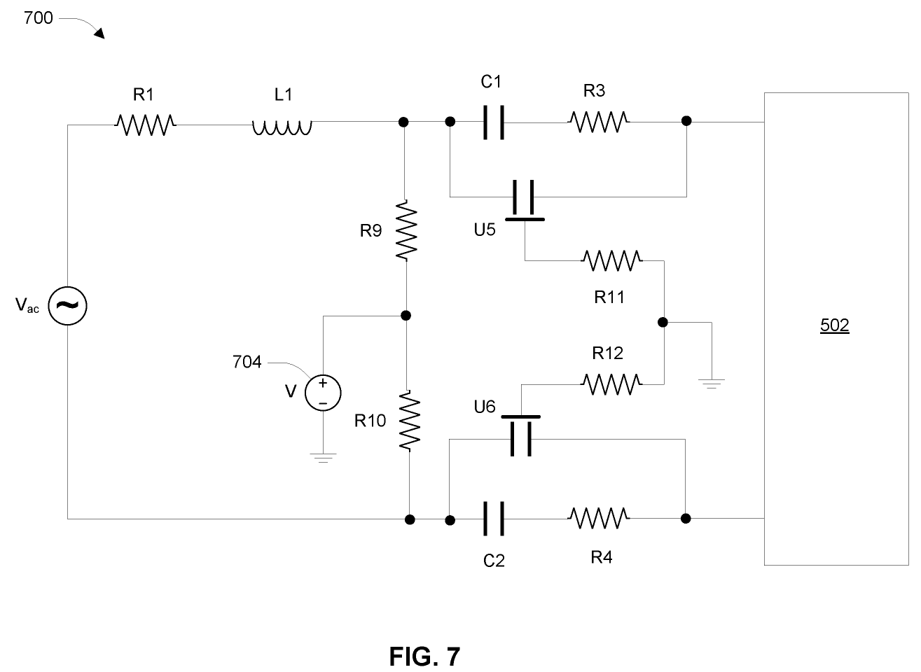

Referring to FIG. 7, an example of a resonant network 700 in a differential-series configuration with a plurality of variable capacitors is shown. The resonant network 700 includes a common control element 704 operably coupled to a first variable reactive element U5 and a second variable reactive element U6. The first variable reactive element U5 and the second variable reactive element U6 may be a transcap, analog variable capacitor technologies, varactors, combinations of varactors, or BST dielectrics/devices. In an example, the common control element 704 provides a positive voltage (e.g., positive polarity control) to a single terminal between two high impedance components such as resistor R9 and resistor R10. In a consumer type product, example values for R9 and R10 are in the range of 50k to 200k ohms. The first variable reactive element U5 is placed in parallel with capacitor C1, and the second variable reactive element U6 is place in parallel with capacitor C2. A third terminal of each of the reactive elements U5, U6 is connected to ground via high impedance components such as resistors R11 and R12 (also in the range of 50k-200k ohms). In general, the high impedance components R9, R10, R11 and R12 are required to maintain an acceptable Quality Factor (i.e., Q factor) in the reactive elements (e.g., variable capacitors). While resistors are shown in FIG. 7, other components may be used to provide the necessary high impedance based on the frequency of the resonant network 700. The configuration of the resonant network 700 provides several advantages. Referring back to FIGS. 5 and 6, the variable reactive element 504, including the elements U3 and U4, is effectively split into the first variable reactive element U5 and the second variable reactive element U6. U5 and U6 remain in a back-to-back configuration with a terminal of U5 coupled to the RF+ side of the resonant network 700, and a terminal of U6 coupled to the RF− side of the resonant network 700. Since the first and second variable reactive elements U5 and U6 are effectively a split of U1, the silicon area required for U5 and U6 is the same as the shunt configuration in FIGS. 5 and 6. This is an advantage over the quadrupling of the silicon are required in prior differential-series configuration. Additionally, both the first and second variable reactive elements U5 and U6 are controlled via the common control element 704, as opposed to the multiple control terminals required in other solutions. The differential-series configuration of the resonant network 700 provides improved linearity because the symmetry of the circuit is maintained. The improved linearity limits the generation of harmonic signals and thus reduces potential EMI issues. The differential-series configuration of the resonant network 700 will also withstand higher voltages as compared to the shunt configuration since the voltages across the first and second variable reactive elements U5 and U6 are generally split (e.g., half the voltage across U1 in FIG. 5). The resonant network 700 provides the advantages of a series configuration (e.g., improved voltage regulation), while reducing the costs and complexity of control previously associated with series resonant circuits.

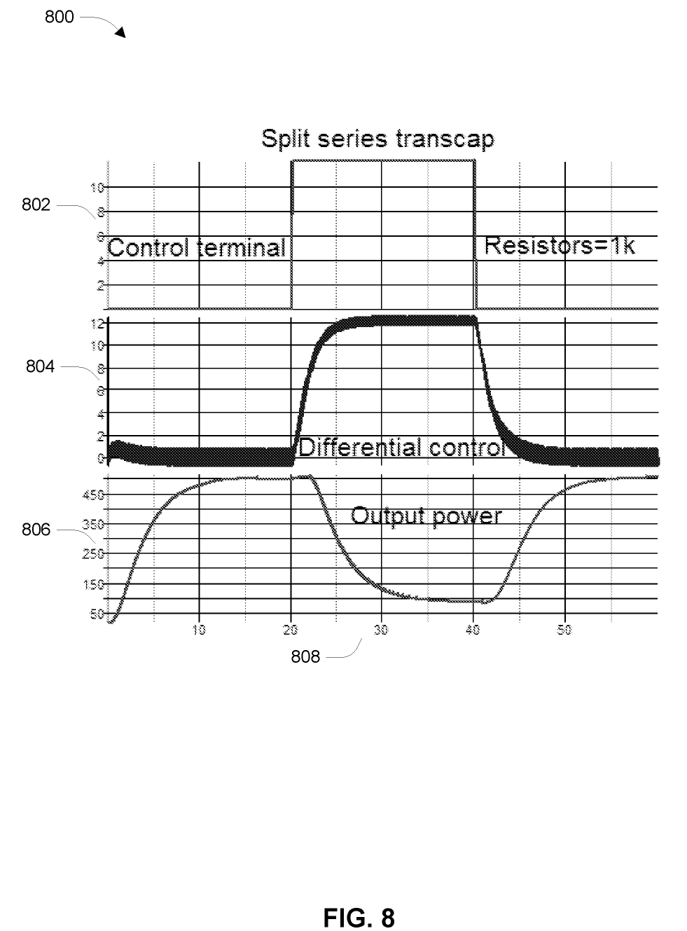

Referring to FIG. 8, a multi-variable graph 800 illustrating an example response of the resonant network in FIG. 7 to a change in a control voltage is shown. The multi-variable graph 800 includes a control voltage terminal input axis 802, a differential control voltage input axis 804, a power output axis 806, and a time axis 808. The signal responses depicted in the graph 800 are based on a simulation of a circuit including the resonant network 700. The resistance values for R9, R10, R11 and R12 were reduced to 1k ohm to speed up the simulation. As examples, and not limitations, the values for the control voltage terminal input axis 802 and the differential control voltage is between 0 and 12 volts. The value for power output is between 0 and 500 mW, and the time axis 808 is in microseconds (e.g., 10 psec/division). The variable values in the graph 800 represent a simulation of the circuit in FIG. 7 based on a control signal input via the common control element 704. In this example, the control voltage terminal input axis 802 represents a square wave voltage at the common control element 704. The differential control voltage input axis 804 represents the difference between the voltage across R4 (i.e., between U6 and C2), and the voltage across R12 (i.e., the voltage at U6 minus the control voltage). The differential control voltage input axis 804 illustrates the association between the RC components and the control voltage terminal input axis 802. In an example, the output circuit includes a rectifier and other power output circuits (e.g., EMI filters), and the power output axis 806 illustrates the corresponding change in power output from the output circuit 502 based on the change in the input at the common control element 704 (e.g., the control voltage terminal input axis 802). That is, the power output axis 806 represents the power that is transferred to the output of a PRU. As depicted in FIG. 8, the output power moves from about ½W (e.g., 500 mW) down to 100 mW when the control voltage input goes to a higher voltage value (e.g., 12V). The power output response illustrates that the resonant network 700 can control the output power of a WPT receiver by changing the reactance of the reactive elements U5 and U6 via the common control element 704.

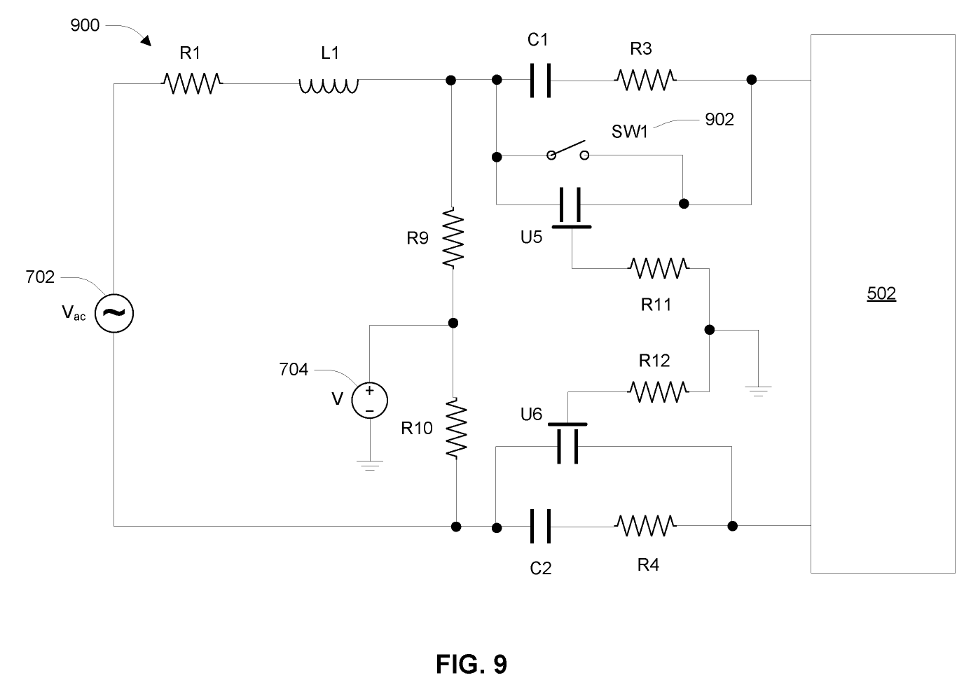

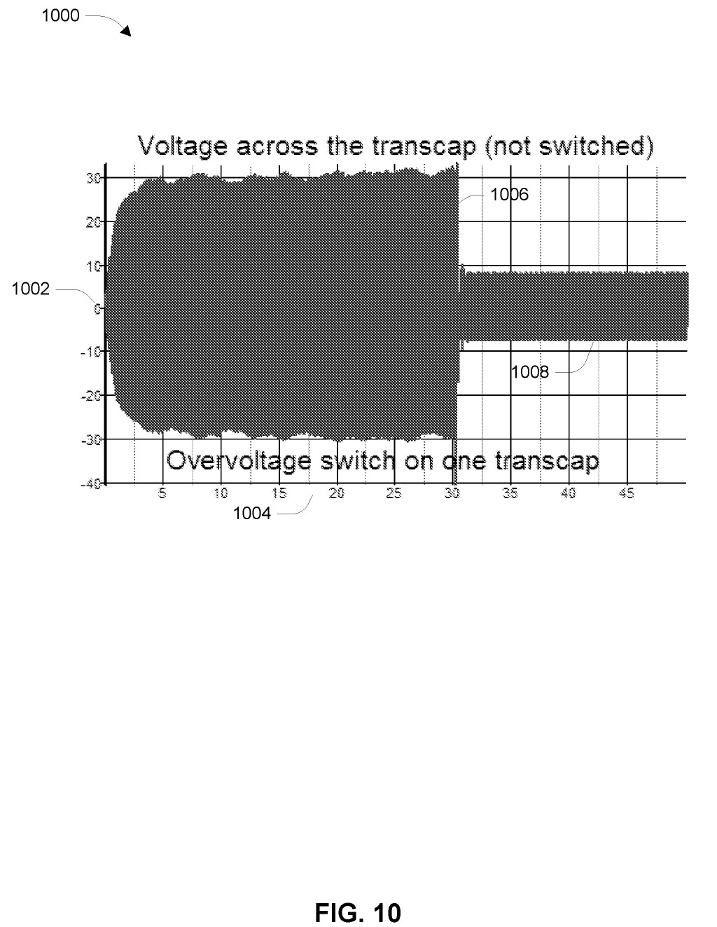

Referring to FIG. 9, with further reference to FIG. 7, another example of a resonant network 900 with an optional switch 902 configured to short out one the reactive elements is shown. The resonant network 900 is the same as depicted in FIG. 7 with the addition of the switch SW1 902 located across one of the reactive elements (e.g., the first variable reactive element U5). The switch SW1 may be operably coupled to the control circuit 408 and configured to open and close to provide overvoltage protection to the resonant network 900 and the output circuit 502. Since the switch SW1 902 effectively causes a bypass of the first variable reactive element U5, the resonant network 900 may be detuned because the capacitance of the network is halved when U5 is removed from the circuit. Referring to FIG. 10, a graph 1000 illustrating the response of the resonant network 900 based on the position of SW1 902 is shown. The graph 1000 includes a voltage axis 1002 and a time axis 1004. In an example, the voltage axis 1002 indicates the voltage into the output circuit 502. The time axis 1004 is shown with in μ seconds (e.g., 5 μsecs/division). The values on the graph 1000 include a first area 1006 (e.g., prior to 30 psec) and a second area 1008 (e.g., after 30 μsec). FIG. 10 demonstrates the result when one of the reactive elements U5, U6 in the resonant network 900 is shorted. For example, when SW1 902 is closed, the resonant element U5 is shorted which results in detuning the resonant network 900 because of instead of having full capacitor for resonance, the circuit now only has half that value. In consumer products, for example, the frequency of the induced voltage is known and fixed (e.g., 6.87 MHz), thus the change of capacitance detunes the circuit away from resonance. The first area 1006 indicates the voltage to the output circuit 502 when the switch SW1 902 is not active (e.g., the output is approximately 60 Vpp). The second area 1008 indicates when the switch SW1 902 is activated (e.g., closed). The voltage in the second area 1008 changes from 60 Vpp to 16 Vpp. This decrease in voltage after the switch SW1 902 is activated may be used to provide overvoltage protection to the resonant network 900. In an example, the control circuit 408 may be configured to measure the voltage across the antenna (e.g., inductor L1). The voltage across the antenna may vary, for example, because the magnetic coupling varies with the position of receiver with respect to the transmitter. The voltage may also vary with the power that is actually transmitted. If the voltage across the antenna exceeds the voltage that is safe for the receiver (e.g., the reactive elements in a resonant circuit may have a maximum voltage which cannot be exceeded), then the control circuit 408 may close the switch SW1 902. By closing the switch SW1 902, the control circuit 408 causes the resonant network 900 to be detuned to make sure the voltage across the antenna is not above an established threshold.

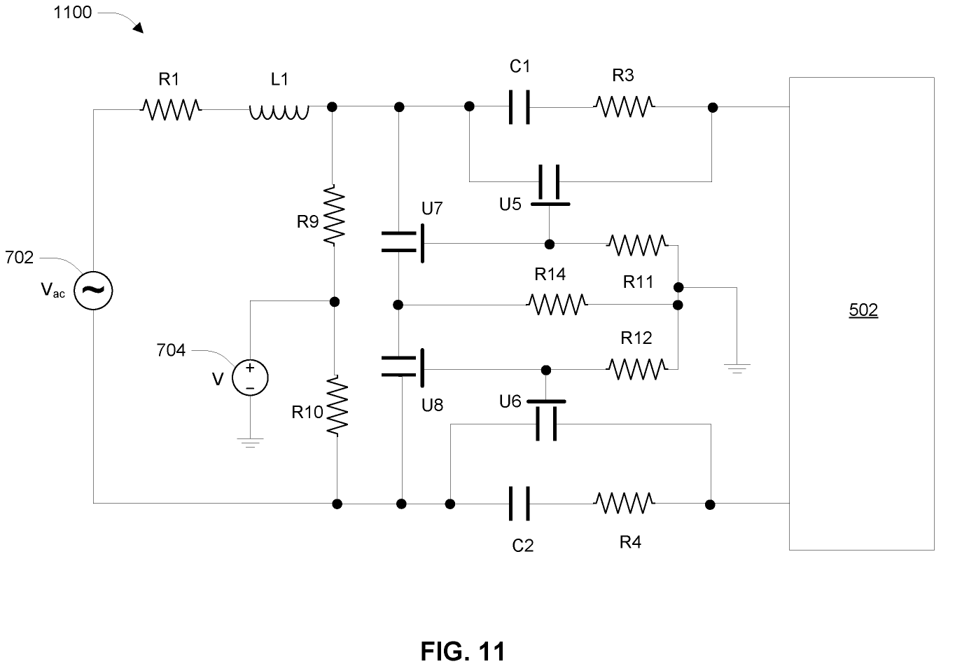

Referring to FIG. 11, with further reference to FIG. 7, an example of a resonant network 1100 in a differential-series configuration with a plurality of variable capacitors in both shunt and series configurations is shown. The resonant network 1100 adds a third variable reactive element U7 and a fourth variable reactive element U8 in a shunt configuration to the differential-series components of FIG. 7. The center of the third and fourth variable reactive elements U7 and U8 is coupled to a high impedance element R14 (e.g., 100k ohm) and then to ground. In an embodiment, the resonant network 1100 utilizes the common control element 704 to control both the shunt and series reactive elements (e.g., U7, U8 and U5, U6). Additional control element may be used if two or more control terminals are required for a specific application. In an embodiment, elements of the resonant network 1100 may be constructed in a semiconductor substrate. For example, the midpoint between the third variable reactive element U7 and the fourth variable reactive element U8 is a gate-oxide, and the p-n junctions are between the first variable reactive element U5 and the third variable reactive element U7, and the second variable reactive element U6 and the fourth variable reactive element U8, respectively.

The values of the components in the resonant networks described herein may vary based on the voltage of operation, technology of the components, and the type of application. For example, the inductance of a resonant network may vary based on size constraints for the application. Small wearable devices such as smart watches, fitness bands, etc. the charging frequency may be around 6.78 MHz and the reactive elements may have values on the order of 200 picofarads. Larger applications such as smartphones may require higher values, and even larger applications such as laptops, medical devices, and vehicles may require even larger values.

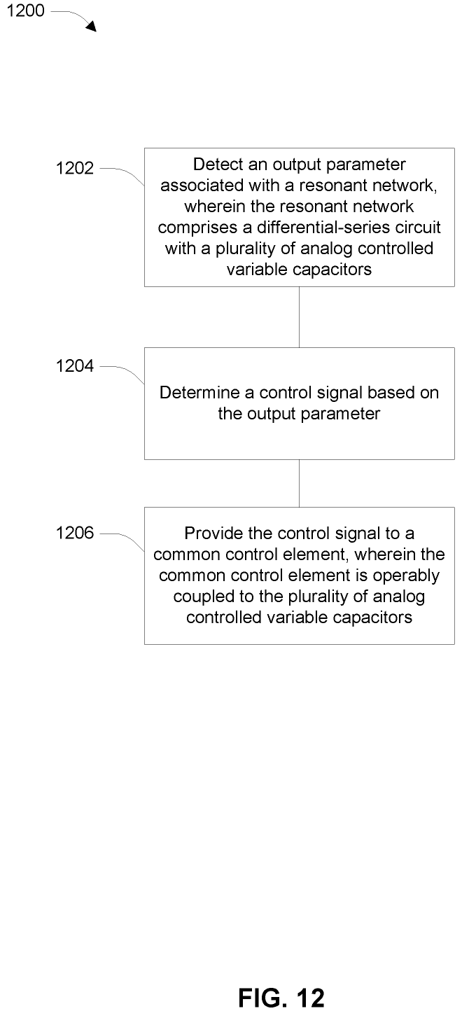

Referring to FIG. 12, an example of a process 1200 of controlling a resonant network in a differential-series configuration is shown. The process 1200 is, however, an example only and not limiting. The process 1200 can be altered, e.g., by having stages added, removed, rearranged, combined, performed concurrently, and/or having single stages split into multiple stages. For example, stage 1204 described below for determining a control signal based on an output parameter can include predetermined values based on expected output parameters. Other alterations to the process 1200 as shown and described are also possible.

At stage 1202 the control circuit 408 detects an output parameter associated with a resonant network, such that the resonant network is a differential-series circuit with a plurality of analog controlled variable capacitors. The plurality of analog controlled variable capacitors includes transcaps, analog variable capacitor technologies, varactors, combinations of varactors, and BST dielectrics/devices. In general, an output parameter is associated with a resonant network if the tuning or detuning of the resonant network will change the value of the output parameter. For example, in a battery charging application the control circuit 408 may receive a voltage and/or current parameter from the output 406. In this application, the voltage and current parameters are examples of output parameters that are associated with the resonant network. In a communications application, the output parameters may be based on the impedance of a transmitting antenna such as a measure of reflected power and/or a standing wave ratio (SWR). The resonant network may be tuned to match the impedance required by the output. These are examples only, and not limitations as other output parameters may be associated with the tuning of a resonant network.

At stage 1204 the control circuit 408 determines a control signal based on the output parameter. The control signal may be based on previously saved values of the output parameters (e.g., a look-up table), or a functional relationship between at least the output parameter and the impedance of the resonant network. In a battery charging application, if the output voltage is below a desired value, the control circuit 408 is configured to determine a control signal required to increase or decrease the impedance to improve the tuning of the resonant network. Typically, the control signal is a positive voltage (e.g., positive voltage control) which corresponds to an impedance value for the resonant network. In an example, if the output parameter indicates an overvoltage condition, the control signal may include providing a voltage to close a bypass switch (e.g., SW1 902) to rapidly detune the resonant network.

At stage 1206, the control circuit 408 provides the control signal to a common control element, such that the common control element is operably coupled to the plurality of analog controlled variable capacitors. The control circuit 408 may provide a voltage (e.g., 0-12V) to the common control element 409 in the resonant network. The plurality of analog controlled variable capacitors may include two variable capacitors on each branch of the differential-series circuit. For example, as depicted in FIG. 7, the common control element 409 may be the common control element 704 operably coupled to the first variable reactive element U5 and the second variable reactive element U6. The plurality of analog controlled variable capacitors may include variable capacitors in both a shunt and series configuration. For example, as depicted in FIG. 11, the common control element 704 is operably coupled to the first variable reactive element U5, the second variable reactive element U6, the third variable reactive element U7, and the fourth variable reactive element U8. In this example, when the voltage of the common control element 704 is varied, the impedance of each of the reactive elements is also varied, with the result of changing the resonant frequency of the resonant network 1100. The process 1200 may be iterative such that after the control signal is provided at stage 1206, the process may loop back to stage 1202 to detect the output parameter.

Other examples and implementations are within the scope and spirit of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

As used herein, unless otherwise stated, a statement that a function or operation is “based on” an item or condition means that the function or operation is based on the stated item or condition and may be based on one or more items and/or conditions in addition to the stated item or condition.

Further, an indication that information is sent or transmitted, or a statement of sending or transmitting information, “to” an entity does not require completion of the communication. Such indications or statements include situations where the information is conveyed from a sending entity but does not reach an intended recipient of the information. The intended recipient, even if not actually receiving the information, may still be referred to as a receiving entity, e.g., a receiving execution environment. Further, an entity that is configured to send or transmit information “to” an intended recipient is not required to be configured to complete the delivery of the information to the intended recipient. For example, the entity may provide the information, with an indication of the intended recipient, to another entity that is capable of forwarding the information along with an indication of the intended recipient.

Substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

The terms “machine-readable medium” and “computer-readable medium,” as used herein, refer to any medium that participates in providing data that causes a machine to operate in a specific fashion. Using a computer system, various computer-readable media might be involved in providing instructions/code to processor(s) for execution and/or might be used to store and/or carry such instructions/code (e.g., as signals). In many implementations, a computer-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, a carrier wave as described hereinafter, or any other medium from which a computer can read instructions and/or code.

Various forms of computer-readable media may be involved in carrying one or more sequences of one or more instructions to one or more processors for execution. Merely by way of example, the instructions may initially be carried on a magnetic disk and/or optical disc of a remote computer. A remote computer might load the instructions into its dynamic memory and send the instructions as signals over a transmission medium to be received and/or executed by a computer system.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Components, functional or otherwise, shown in the figures and/or discussed herein as being connected or communicating with each other are communicatively coupled. That is, they may be directly or indirectly connected to enable communication between them.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

Further, more than one invention may be disclosed.

1. An apparatus for controlling an output parameter with a resonant network, comprising:
the resonant network comprising a differential-series circuit with a first variable reactive element on a first branch of the differential-series circuit and a second variable reactive element on a second branch of the differential-series circuit, wherein the resonant network is coupled to an output circuit;
a common control element operably coupled to the first variable reactive element and the second variable reactive element; and
a control circuit operably coupled to the output circuit and the common control element and configured to vary an impedance of the resonant network based on a value of the output parameter in the output circuit.

2. The apparatus of claim 1 wherein the first variable reactive element and the second variable reactive element are analog controlled variable capacitors.

3. The apparatus of claim 1 wherein the first variable reactive element and the second variable reactive element include Barium Strontium Titanate (BST) devices.

4. The apparatus of claim 1 wherein the first variable reactive element and the second variable reactive element include varactors.

5. The apparatus of claim 1 wherein the control circuit is configured to provide a positive voltage to the common control element.

6. The apparatus of claim 1 wherein the output parameter is a voltage in the output circuit.

7. The apparatus of claim 1 wherein the output parameter is an impedance value in the output circuit.

8. The apparatus of claim 1 wherein the resonant network further comprises a third variable reactive element and a fourth variable reactive element in a shunt configuration between the first branch and the second branch, and the common control element is operably coupled to the third variable reactive element and the fourth variable reactive element.

9. The apparatus of claim 1 wherein the resonant network includes a power receiving element.

10. The apparatus of claim 1 wherein the output circuit includes a rectifier circuit and a charge controller configured to charge a battery.

11. The apparatus of claim 1 wherein the first branch and the second branch of the differential-series circuit each include a high impedance resistor.

12. The apparatus of claim 1 wherein the first branch and the second branch of the differential-series circuit are equal.

13. A method of controlling an output parameter with a resonant network, comprising:
detecting the output parameter, wherein the output parameter is associated with the resonant network and the resonant network comprises a differential-series circuit with a plurality of analog controlled variable capacitors;
determining a control signal based on the output parameter; and
providing the control signal to a common control element, wherein the common control element is operably coupled to the plurality of analog controlled variable capacitors.

14. The method of claim 13 wherein the output parameter is a voltage.

15. The method of claim 13 wherein the output parameter is a measure of reflected power from a load.

16. The method of claim 13 wherein the control signal is a positive voltage.

17. The method of claim 13 wherein the plurality of analog controlled variable capacitors are in a differential-series configuration and a shunt configuration.

18. A resonant circuit in a wireless power receiving unit, comprising:
a power receiving element including a first inductor;
a first high impedance component coupled in series to a second high impedance component, wherein the first and second high impedance components are in a shunt configuration with respect to the power receiving element;
a common control element with a first terminal coupled to a point between the first and second high impedance components and a second terminal operably coupled to ground;
a first capacitor with a first terminal operably coupled to the first high impedance component and the power receiving element and a second terminal operably coupled to an output;
a second capacitor with a first terminal operably coupled to the second high impedance component and the power receiving element and a second terminal operably coupled to the output;
a first variable reactive element operably coupled in a parallel configuration to the first capacitor, the first variable reactive element including a control terminal operably coupled to ground via a third high impedance component; and
a second variable reactive element operably coupled in a parallel configuration to the second capacitor, the second variable reactive element including a control terminal operably coupled to ground via a fourth high impedance component.

19. The resonant circuit of claim 18 wherein the common control element is configured to provide a positive voltage to the point between the first and second high impedance components.

20. The resonant circuit of claim 18 wherein a first capacitance value in the first variable reactive element is based on a voltage at the common control element.

21. The resonant circuit of claim 18 wherein a second capacitance value in the second variable reactive element is based on a voltage at the common control element.

22. The resonant circuit of claim 18 wherein a first capacitance value in the first variable reactive element and a second capacitance value in the second variable reactive element are based on a voltage at the common control element, wherein the first capacitance value and the second capacitance value are equal.

23. The resonant circuit of claim 18 wherein the first high impedance component, the second high impedance component, the third high impedance component and the fourth high impedance component are resistors.

24. The resonant circuit of claim 18 wherein the first high impedance component, the second high impedance component, the third high impedance component and the fourth high impedance component have equal impedance values.

25. The resonant circuit of claim 18 further comprising a switch operably coupled in a parallel configuration to the first variable reactive element and configured to bypass the first variable reactive element when the switch is in a closed position.

26. The resonant circuit of claim 18 wherein the output comprises a rectifier circuit and a battery.

27. An apparatus for controlling a resonant network, comprising:
the resonant network comprising a differential-series circuit with a first variable reactive means on a first branch of the differential-series circuit and a second variable reactive means on a second branch of the differential-series circuit; and
a common control means operably coupled to the first variable reactive means and the second variable reactive means, and configured to vary an impedance of the resonant network.

28. The apparatus of claim 27 wherein the common control means is configured to provide a voltage to the first variable reactive means and the second variable reactive means to vary the impedance of the resonant network.

29. The apparatus of claim 27 wherein the first variable reactive means and the second variable reactive means are analog controlled variable capacitors.

30. The apparatus of claim 27 further comprising a switch means operably coupled to the first variable reactive means and configured to bypass the first variable reactive means when the switch means is closed.
